(19) United States
(12) Patent Application Publication
(10) Pub. No.: US 2009/0079541 A1
(43) Pub. Date: Mar. 26, 2009

(54) CONFIGURING SPECTRUM AGILE DEVICES BY MEANS OF LABELS STORING SPEKTRUM OPPORTUNITY PARAMETERS

(75) Inventor: Yasser Alsafadi, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,254

(22) PCT Filed: Oct. 28, 2005
(86) PCT No.: PCT/IB05/53533

§ 371 Date: Apr. 30, 2007

(30) Foreign Application Priority Data
Nov. 3, 2004 (EP) 04105476.8

(51) Int. Cl. H04W 88/14

(52) U.S. Cl. 340/10.1

(57) ABSTRACT

A device (DEV) which is capable of communicating using different spectrum opportunities comprises a communication unit (CMM) capable of communicating with other devices (DEV) and/or with communication networks, wherein the communication unit (CMM) is capable of communicating using different spectrum opportunities, and wherein a spectrum opportunity is defined by a set of at least one spectrum opportunity parameter; a label reader (REU; REU) capable of reading information (inf) from a label (TAG), wherein the information identifies at least one spectrum opportunity parameter of a spectrum opportunity; and switching means capable of switching the communication unit (CMM) to communicate using the spectrum opportunity as at least partially identified by the information (inf) read from the label (TAG).

### FIELD OF THE INVENTION

The invention relates to a device which is capable of communicating using different spectrum opportunities.

The invention further relates to a method for switching a device which is capable of communicating using different spectrum opportunities to a certain spectrum opportunity.

The invention further relates to a label with storage means.

### BACKGROUND OF THE INVENTION

Smart labeling is the latest Radio frequency identification (RFID) technology, combining the advantages of barcode, Electronic Article Surveillance (EAS) and traditional RFID solutions. RFID systems allow for non-contact reading in manufacturing and other types of environments where barcode labels may not perform properly or be practical. RFID has applications in a wide range of markets including automated vehicle identification (AVI) systems and livestock identification because of its capability to track moving objects. The technology has become a primary player in identification, automated data collection, and analysis systems worldwide.

Such systems are designed to serve mass markets with many millions of labels needed per year. For example, Philips Semiconductors' ICODE ICs represent the state-of-the-art in smart label technology, offering a low-cost, re-programmable and disposable solution for source tagging, automatic data capture, theft protection and data storage on a product or its packaging. ICODE smart labels allow almost any item to be tagged for efficient handling. ICODE's highly automated item scanning process does not require line-of-sight and can scan multiple labels at the same time.

ICODE smart labels offers considerable benefits in a broad variety of applications. In airline baggage tagging and parcel services, smart labels offer considerable advantages in sorting and item tracking. In supply chain management systems, smart labels overcome the limitations of barcode technology, providing improved product distribution; and in libraries and rental applications, they provide automated check-in, check-out and inventory control.

The growth of wireless services of the past several years demonstrates the vast and growing amount of businesses, consumers, and government for spectrum-based communication links. Spectrum access, efficiency, and reliability have become critical public policy issues. Advantages in technology are creating the potential for radio systems to use spectrum more intensively and more efficiently than in the past. Among these advantages are cognitive radio technologies that can make possible more intensive and efficient spectrum use by licensees within their own networks, and by spectrum users sharing spectrum access on a negotiated or an opportunistic basis. These technologies include, among other things, the ability of devices to determine their location, sense spectrum use by neighbouring devices, change frequency, adjust output power, and even alter transmission parameters and characteristics. These radio technologies open spectrum for use in space, time, and frequency dimensions that until now have been unavailable. For example, such technologies can be employed in applications such as wireless LANs (“Local Area Network”) and mobile wireless service networks, and promise greater future benefits (e.g., Federal Communications Commission, Notice of Proposed Rule Making and Order, Facilitating Opportunities for Flexible, Efficient, and Reliable Spectrum Use Employing Cognitive Radio Technologies, FCC 03-322, 2003).

Spectrum agile radio devices employ sophisticated techniques to identify a spectrum opportunity. The document “Spectrum Agile Radio: Detecting Spectrum Opportunities” of Kiran Challapali, Stefan Mangold, Zhun Zhong (Wireless Communications and Networking Department, Philips Research Laboratories, Briarcliff Manor N.Y. 10510, USA) describes the complexity involved in detecting a spectrum opportunity. This paper presents the Hugh Transform, autocorrelation function, and Clear Channel Assessment for identifying radio sources and detecting spectrum opportunities. Implementing these techniques add to the costs of a device.

### OBJECT AND SUMMARY OF THE INVENTION

It is an object of the invention to provide a device of the type defined in the opening paragraph and a method of the type defined in the second paragraph, which allow to identify spectrum opportunities to such devices in a simple way and at a low cost.

In order to achieve the object defined above, with a device according to the invention characteristic features are provided so that a device according to the invention can be characterized in the way defined below, that is:

A device, which is capable of communicating using different spectrum opportunities comprising:

a communication unit capable of communicating with other devices and/or with communication networks, wherein the communication unit is capable of communicating using different spectrum opportunities, and wherein a spectrum opportunity is defined by a set of at least one spectrum opportunity parameter;
a label reader capable of reading information from a label, wherein the information identifies at least one spectrum opportunity parameter of a spectrum opportunity; and
switching means capable of switching the communication unit to communicate using the spectrum opportunity as at least partially identified by the information read from the label.

In order to achieve the object defined above, with a method according to the invention characteristic features are provided so that a method according to the invention can be characterized in the way defined below, that is:

A method for switching a device, which is capable of communicating using different spectrum opportunities to a certain spectrum opportunity, wherein a spectrum opportunity is defined by a set of at least one spectrum opportunity parameter, comprising the following steps:
(i) the device reads information identifying at least one spectrum opportunity parameter of a spectrum opportunity from a label;
(ii) the device switches its communication unit to the spectrum opportunity which spectrum opportunity is at least partially identified by the information read from the label.

In order to achieve the object defined above, with a label according to the invention characteristic features are provided so that a label according to the invention can be characterized in the way defined below, that is:

A label with storage means, wherein information identifying at least one spectrum opportunity parameter of at least one spectrum opportunity is stored in the storage means.

The characteristic features according to the invention provide the advantage that it is not necessary to employ sophisticated techniques to identify a spectrum opportunity to a device. According to the invention labels are used to identify spectrum opportunities. An entity (person, organization, . . . ) can purchase or lease a spectrum opportunity stored on a label and makes the spectrum opportunity available to a device. The device simply adjusts its communication unit according to the spectrum opportunity as identified by the information stored on the label and starts communicating using this spectrum opportunity.

In principle the use of arbitrary labels or tags, such as barcodes, is conceivable. However, using an RFID (“Radio Frequency Identification”) tag reader provides the advantage that a low-cost, re-programmable and disposable solution is applied for identifying a spectrum opportunity to a device. Furthermore, using RFID tags (labels) does not require line-of-sight between the label reader and the label, which makes the use more comfortable.

Using an external reader provides the advantage that devices which do not have an internal reader can be used also in the context of the invention.

Using an internal reader provides the advantage that compact devices can be used.

Using spectrum opportunity parameters provides the advantage that after retrieving the information from a label the device can immediately adjust the communication unit and start communicating.

In another embodiment the complete set of spectrum opportunity parameters defining a spectrum opportunity are stored on the label, and after storing the spectrum opportunity read from the label the device can start communicating.

However, the above mentioned embodiment makes it necessary to store all the spectrum opportunity parameters of the spectrum opportunity on the label. Another embodiment provides the advantage that it is not necessary to store the whole spectrum opportunity on the label. In this embodiment the label contains only information, which is related to or describes a certain spectrum opportunity. For example, the information is a key, which is connected to a certain spectrum opportunity. The device sends the key to the database and receives the spectrum opportunity from the database.

A further advantage of this embodiment is that there is no restriction with respect to the amount of storage on the label since only a simple key has to be stored, and that a spectrum opportunity can—if necessary—easily be changed in a central place, namely in the database, even if labels referring to the spectrum opportunity to be changed are already sold.

In this embodiment the information of the label may completely identify a spectrum opportunity which is then retrieved form the database.

However, it can also be of advantage when device-dependent parameters are realized. In this embodiment specific parameters with respect to the device and/or the environment may be taken into account when specifying a spectrum opportunity to be used by the device.

### BRIEF DESCRIPTION OF THE DRAWINGS

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

FIG. 1 shows a device according to the invention in the form of a block diagram.

FIG. 2 shows a second embodiment of a device according to the invention in the form a block diagram.

FIG. 3 shows a method according to the invention in a diagram.

FIG. 4 shows a further method according to the invention in a diagram.

### DESCRIPTION OF EMBODIMENTS

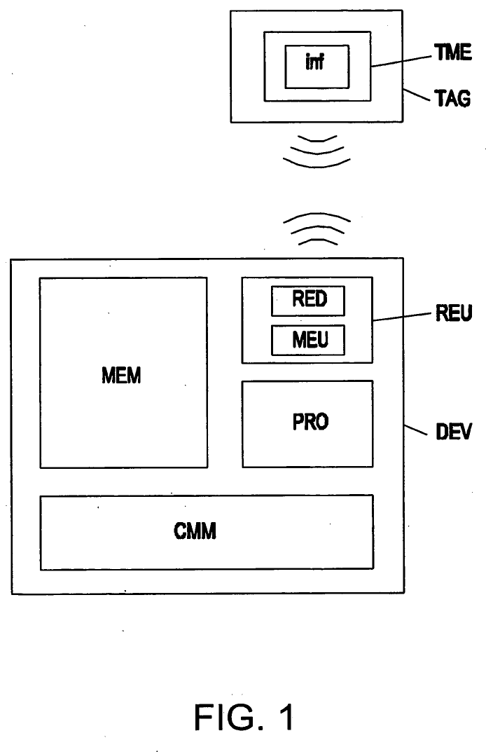

FIG. 1 shows a first embodiment of a device DEV according to the invention. Examples for devices DEV according to the invention are wireless devices in general, e.g., home, office or factory appliances that use wireless communication to exchange commands or information. The communication may take place directly between different devices or a device according to the invention may be connected to a network such as a (wireless) LAN. For example, devices DEV according to the invention may also be used for mobile wireless services.

In this example, the device DEV includes a processor PRO and a memory MEM. The processor PRO may represent, e.g., a microprocessor, a central processing unit, a computer, a circuit card, an application-specific integrated circuit (ASICs), as well as portions or combinations of these and other types of processing device which are already part of the device DEV. The memory MEM may represent, e.g., disk-based optical or magnetic storage units, electronic memories, as well as portions or combinations of these and other memory devices.

As shown, the device DEV also includes a communication unit CMM (e.g., Bluetooth, cellular, 802.11, WMTS (“Wireless Medical Telemetry Spectrum”), GSM, . . . ) which is capable of communicating with networks, such as Wireless/WLAN network with other devices using different spectrum opportunities. Such devices DEV are also known as “spectrum agile radios”.

A spectrum opportunity is defined by a set of at least one spectrum opportunity parameter. The frequency or a range of frequency is such a spectrum opportunity parameter. In general, a certain spectrum opportunity is described by a number of parameters. Examples for such parameters are the following:
(i) a chunk of spectrum (frequency or frequency range),
(ii) a MAC scheme,
(iii) a length of time,
(iv) a location (geographical, . . . ),
(v) an angular direction (e.g., for directional antennas),
(vi) a relaxation of the FCC policy constraints by a primary (for example,
   an FCC policy constrains transmission to 100 mW, however, the opportunity described allows to relax the rules to transmit up to 1 W), or
(vii) a combination(s) of all or some of the above items, or pluralities of the above items.

In the following a concrete example for a spectrum opportunity is described:

### Spectrum=650 MHz

### MAC=802.11 Like

Time=2 hours starting form Oct. 21, 2004 and ending Jan. 21, 2005

### Location=New York City USA

Angular direction=none

### Relaxation of Policy: Power=1 w.

That is, the device can access spectrum at 650 MHz using a 802.11 like access control, for a total period of 2 hours starting Oct. 21, 2004 and ending Jan. 21, 2005 while in New York City USA, and can use a maximum power of 1 W.

It should be noted that the above mentioned parameters are the parameters most frequently used to describe spectrum opportunities. The spectrum opportunity parameters (i), (ii) and (iv) are the parameters which are most important and which are usually defined in every spectrum opportunity. However, further parameters which are not listed here can also be used alternatively and/or additionally for the description of a spectrum opportunity.

Furthermore, the device DEV comprises switching means to switch the communication unit CMM to a certain spectrum opportunity. For example, these switching means may be implemented in the communication unit CMM, or other parts of the device DEV, e.g. the processor PRO and memory MEM together with software are capable of switching the communication unit CMM to a certain spectrum opportunity.

When the device obtains a new spectrum opportunity, the switching means adjust the communication unit CMM, i.e., the MAC (“Medium Access Control”) layer and the physical layer, which is concerned with the electrical, mechanical and timing aspects of signal transmission over a communication medium, to the spectrum opportunity parameters of the new spectrum opportunity. The device DEV can include any one or more of a variety of well known physical layers such as cellular and Bluetooth. Furthermore, the device DEV comprises an internal label reader REU which is capable of reading information inf from a label TAG. The label TAG comprises an RFID tag. The label reader REU is an RFID type reader. In principle, other types of labels/reading mechanisms may be used, e.g., a barcode reader. However, as pointed out in the introductory part the use of RFID tags is of advantage. The RFID tag may be active or passive.

The RFID tag TAG consists in principle of an antenna, an analogous circuit for receiving and sending (transponder), as well as a digital circuit and a permanent memory TME. However, these hardware features of an RFID tag are well known to a person skilled in the art and therefore are not shown in the figure.

Accordingly, the reader RFID tag reader REU is only shown schematically. The tag reader REU consists of a memory MEU and reading means RED (antenna, etc.) to communicate with the RFID tag TAG.

Information inf identifying a certain spectrum opportunity is stored in the memory TME of the RFID tag TAG. Usually information concerning only one spectrum opportunity is stored on the RFID tag TAG. However, it is also possible that more than one spectrum opportunity (or more portions of information, each information describing a spectrum opportunity) are stored on the RFID tag TAG.

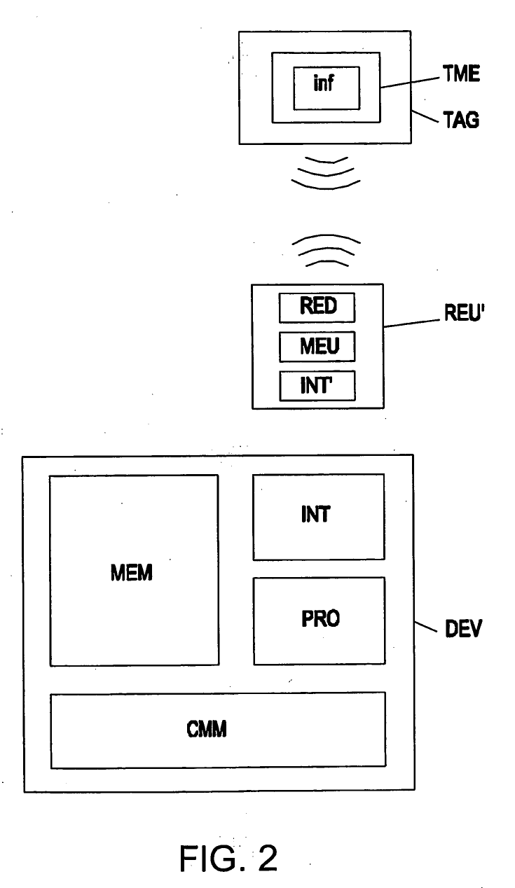

FIG. 2 shows a second embodiment of the device DEV according to the invention. The device DEV shown in FIG. 2 differs from the device shown in FIG. 1 by that fact that it has no internal label reader but is connectable to an external label reader REU′. The external RFID tag reader REU′ and the device can be coupled via interfaces INT, INT′, for example via serial interfaces.

With the label reader REU, REU′ the device DEV reads out the information inf concerning a spectrum opportunity from the RFID tag TAG. After storing the spectrum opportunity in its memory MEM the device DEV adjusts the communication unit CMM according to the spectrum opportunity parameters of the new spectrum opportunity. After adjusting the communication unit CMM the unit can start communicating using the new spectrum opportunity.

In principle, there are two possibilities to make the spectrum opportunity parameters available to the device DEV:

(i) All parameters which the device DEV needs to communicate using the new spectrum opportunity are stored directly on the RFID tag TAG. This embodiment provides the advantage that everything the device DEV needs is stored on the RFID tag TAG, and that it is therefore not necessary to establish a connection to a database to receive the spectrum opportunity parameters. A possible disadvantage of this embodiment may be that the spectrum opportunity parameters stored on the RFID tag TAG are static, and reflect a market or opportunity condition when the spectrum opportunity was stored.

(ii) The information inf stored on the RFID tag TAG does not contain the spectrum opportunity parameters but only a key which is identifying a spectrum opportunity. The spectrum opportunity itself is stored in a database, and the device may obtain (download, via an SMS, MMS, etc.) the spectrum opportunity parameters from the database. The main advantage of this embodiment is that the spectrum opportunity reflects the market or opportunity conditions when the RFID tag TAG is used, and not when the information is stored on the RFID tag TAG. A disadvantage of this embodiment may be the fact that the device should have the means to communicate with the database.

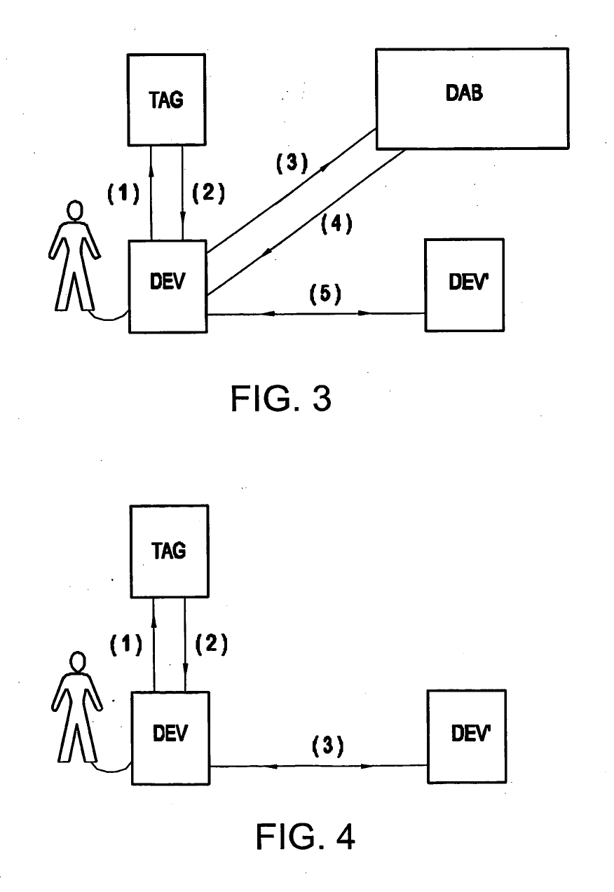

FIG. 3 describes a method according to the invention with respect to the situation where the information inf stored on the RFID tag TAG contains a key identifying a spectrum opportunity. In a first step a user connects with his device DEV to an RFID tag TAG (1) and reads out the information inf (2). In the following step the device DEV connects to a database DAB (3), on which spectrum opportunities are stored. According to the information inf received from the RFID tag TAG and sent from the device DEV to the database DAB a certain spectrum opportunity is transferred to the device DEV (4). As mentioned above, the spectrum opportunity (parameters) may be sent to the device DEV from the database DAB, or the device DEV may download the spectrum opportunity (parameters) from the database DAB.

After receiving the spectrum opportunity the device DEV stores the spectrum opportunity, adjusts the communication unit CMM and can start communicating with another device DEV′ using the new spectrum opportunity (5). The communication with the device DEV′ may take place directly or via wireless/WLAN network.

The device DEV could communicate with the database DAB by establishing a connection. This connection could be wired or wireless. It may be possible that the device DEV uses the communication unit CMM for communicating with the database DAB. In this embodiment it is of advantage that a fixed wireless scheme is used. However, it may also be possible that the device DEV needs further means (which are not shown in the figure) for communicating with the database DAB (for example, if the communication unit CMM is a Bluetooth-communication unit, and the database DAB is connected to the internet).

FIG. 4 shows an example where the information inf stored on the RFID tag TAG contains the spectrum opportunity parameters. A user connects his device DEV to the RFID tag TAG (1) and receives the information inf containing the spectrum opportunity parameters (2). The spectrum opportunity is stored in the device DEV, the communication unit CMM is adjusted and the device DEV can start communicating with another device DEV′ (3).

The following paragraph show actions taken by a device DEV according to the invention depending on the incoming information of an RFID tag TAG:

(a) information=none; meaning: one spectrum opportunity already stored in the device DEV; action: the device DEV uses the spectrum opportunity already stored on the device DEV

(b) information=description of a spectrum opportunity; meaning: one spectrum opportunity stored on the RFID tag TAG; action: copy the spectrum opportunity from the RFID tag TAG to the device DEV, using this spectrum opportunity for communication

(c) information=identification (ID) of the RFID tag TAG; meaning: this is a (primary) key for a spectrum opportunity in a database DAB; retrieve the spectrum opportunity identified by the key from the database DAB, use the spectrum opportunity for communication

(d) information=identification (ID) of the RFID tag TAG and identification of the reader REU, REU′ (or the device); meaning: 2 (primary) keys in the spectrum opportunity database DAB; retrieve the spectrum opportunity identified by the keys from the database DAB, use the spectrum opportunity for communication

(e) information=identification (ID) of the RFID tag TAG and identification of the reader REU, REU′ (or the device) and environment variables; meaning: 3 (primary) keys in the spectrum opportunity database DAB; retrieve the spectrum opportunity identified by the keys from the database DAB, use the spectrum opportunity for communication In scenario (d) 2 keys, one of the RFID tag TAG and one of the device DEV, together identify one spectrum opportunity.

In scenario (e) 2 keys and further (environment) define a spectrum opportunity. For example, some new tags have sensors that which measure environment variables (heat, light, pressure,), or the device comprises such sensors.

In scenarios (d) and (e) the RFID tag TAG only provides partial, but essential, identification of the spectrum opportunity, for example the frequency and the MAC scheme, whereas other spectrum opportunity parameters are defined by the device DEV and/or environment variables.

Summarizing, there are the following possibilities:

i) one or more spectrum opportunities (or the corresponding information/key(s)) are completely stored on a label

ii) one or more spectrum opportunities (or the corresponding information(key(s)) are partially stored on a label; further spectrum opportunity parameters completely defining a spectrum opportunity are then defined by the device and/or environment variables, and/or by other labels (see point iii) below)

iii) the spectrum opportunity parameters (or the corresponding information/key(s)) associated with one spectrum opportunity may also be stored on a number of labels

The invention allows to identify spectrum opportunities to devices in a simple way and therefore does not add to the costs and complexities of the devices.

Furthermore, devices DEV according to the invention can operate as secondary users of spectrum (Federal Communications Commission, Notice of Proposed Rule Making and Order, Facilitating Opportunities for Flexible, Efficient, and Reliable Spectrum Use Employing Cognitive Radio Technologies, FCC 03-322, 2003). This means that there is a need for a device to obtain a guaranteed use of the spectrum, and not to depend on its luck in finding a spectrum opportunity. This opens a market for sub-licensing of spectrum. The invention enables the distribution of sub-licenses of spectrum.

For example, a spectrum agile wireless device DEV wants to communicate with similar devices. However, it operates in a geographical area that has many devices competing for spectrum. It is conceivable that an entity sub-license the spectrum in that area and is reselling/re-distributing chunks of the spectrum (a frequency or a frequency range). Thus, the RFID tag TAG is associated with a guaranteed spectrum opportunity. As previously described the wireless device DEV reads the RFID tag TAG and obtains the parameters and performs the actions indicated above. The wireless device DEV can start communicating using the parameters describing the spectrum opportunity.

It should be noted that the above-mentioned embodiments illustrate rather than limit the invention, and that those skilled in the art will be capable of designing many alternative embodiments without departing from the scope of the invention as defined by the appended claims. In the claims, any reference-signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A device (DEV) which is capable of communicating using different spectrum opportunities comprising:
a communication unit (CMM) capable of communicating with other devices (DEV′) and/or with communication networks, wherein the communication unit (CMM) is capable of communicating using different spectrum opportunities, and wherein a spectrum opportunity is defined by a set of at least one spectrum opportunity parameter;
a label reader (REU; REU′) capable of reading information (inf) from a label (TAG), wherein the information identifies at least one spectrum opportunity parameter of a spectrum opportunity; and
switching means capable of switching the communication unit (CMM) to communicate using the spectrum opportunity as at least partially identified by the information (inf) read from the label (TAG).

2. A device according to claim 1, wherein the label reader (REU; REU′) is an RFID tag reader.

3. A device according to claim 1, wherein the label reader is an external reader (REU′) which is connectable to the device (DEV).

4. A device according to claim 1, wherein the label reader (REU) is integrated into the device (DEV).

5. A device according to claim 1, wherein the information (inf) read from the label (TAG) contains spectrum opportunity parameters.

6. A device according to claim 1, wherein the device (DEV) is capable of communicating with a spectrum opportunity database (DAB), and wherein the device (DEV) retrieves, after sending of at least the information (inf) read from the label (TAG) to the database (DAB), a spectrum opportunity from the spectrum opportunity database (DAB) which spectrum opportunity is at least partially identified by the information (inf) sent to the database (DAB).

7. A device according to claim 1, wherein a spectrum opportunity is completely identified by the information (inf) read from the label (TAG).

8. A device according to claim 1, wherein further spectrum opportunity parameters of a spectrum opportunity are identified by device-dependent parameters and/or environment variables.

9. A method for switching a device (DEV) which is capable of communicating using different spectrum opportunities to a certain spectrum opportunity, wherein a spectrum opportunity is defined by a set of at least one spectrum opportunity parameter, comprising the following steps:
(i) the device (DEV) reads information (inf) identifying at least one spectrum opportunity parameter of a spectrum opportunity from a label (TAG);
(ii) the device (DEV) switches its communication unit (CMM) to the spectrum opportunity which spectrum opportunity is at least partially identified by the information (inf) read from the label (TAG).

10. A method according to claim 9, wherein the information (inf) read from the label (TAG) contains spectrum opportunity parameters.

11. A method according to claim 9, wherein after step (i) the device (DEV) connects to a spectrum opportunity database (DAB), sends the information (inf) retrieved from the label (TAG) to the database (DAB), and retrieves a spectrum opportunity which spectrum opportunity is at least partially identified by the information (inf) read from the label (TAG).

12. A method according to claim 9, wherein a spectrum opportunity is completely identified by the information (inf) read from the label (TAG).

13. A method according to claim 9, wherein further spectrum opportunity parameters of a spectrum opportunity are identified by device-dependent parameters and/or environment variables.

14. A method according to claim 9, wherein the label (TAG) is an RFID tag.

15. A label (TAG) with storage means (TME), wherein information (inf) identifying at least one spectrum opportunity parameter of at least one spectrum opportunity is stored in the storage means (TME).

16. A label (TAG) according to claim 15, wherein the label (TAG) is an RFID tag.

17. A label (TAG) according to claim 15, wherein the information (inf) stored in the label (TAG) contains spectrum opportunity parameters.

18. A label (TAG) according to claim 15, wherein a spectrum opportunity is completely identified by the information (inf) read from the label (TAG).
